(19) United States
(12) Patent Application Publication
(10) Pub. No.: US 2012/0290575 A1
(43) Pub. Date: Nov. 15, 2012

(54) MINING INTENT OF QUERIES FROM SEARCH LOG DATA

(75) Inventors: Yunhua Hu, Beijing (CN); Daxin Jiang, Beijing (CN); Hang Li, Beijing (CN)

(73) Assignee: Microsoft Corporation, Redmond, WA (US)

(21) Appl. No.: 13/103,989

(22) Filed: May 9, 2011

(51) Int. Cl. G06F 17/30

(52) U.S. Cl. 707/737; 707/E17.046

(57) ABSTRACT

Architecture that mines intent of a query from search log data. For example, for a given query, the intent, the major URLs for the intent, and intent attributes, are found. The input is search log data and the output is a database that contains the intent of queries mined from the log data. Data mining techniques are employed to discover major intents of queries in the click-through log data of a search engine. For each query, its expanded queries are created and utilized, as well as co-clicks of the original query and expanded queries in the log data. For each query, clustering is performed on the co-click data of the query and expanded queries to find the major intents of the query.

### BACKGROUND

In search processes, understanding the intent of queries submitted by the users is desirable. However, in most cases, the query can be interpreted to be related to many different topics. For example, the query “fast” could relate to a computer game, an enterprise search company, or a movie. If the search system can understand the intent of query each time, the system will be able to effectively help the user to find information. However, existing systems fail to identify query intent.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed is architecture that mines intent of a query from search log data. For example, for a given query, the intents, the major URLs for the intents, and intent attributes, are found. The input is search log data and the output is a database that contains the intents of queries mined from the log data. Data mining techniques are employed to discover major intents of queries in the click-through log data of a search engine. For each query, its expanded queries are created and utilized. The expanded queries can be determined according to formats of query+attribute, and attribute+query, for example, as well as co-clicks of uniform resource locators (URLs) of the original query and expanded queries in the log data. For each query, clustering is performed on the co-click data (e.g., URLs) of the query and expanded queries to find the major intents of the query.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an intent mining system in accordance with the disclosed architecture.

FIG. 2 illustrates an alternative embodiment of an intent mining system.

FIG. 3 illustrates a flow diagram of intents mining using a query tree relationship structure.

FIG. 4 illustrates an example of search log data as queries and expanded queries in search log data in accordance with the disclosed architecture.

FIG. 5 illustrates query relations in search log data.

FIG. 6 illustrates a clustering process for clustering of URLs to generate intents.

FIG. 7 illustrates a computer-implemented intent mining method in accordance with the disclosed architecture.

FIG. 8 illustrates further aspects of the method of FIG. 7.

FIG. 9 illustrates an alternative intent mining method in accordance with the disclosed architecture.

FIG. 10 illustrates further aspects of the method of FIG. 9.

FIG. 11 illustrates an alternative method of intent mining.

FIG. 12 illustrates a block diagram of a computing system that executes intent mining in accordance with the disclosed architecture.

### DETAILED DESCRIPTION

Given a query, the disclosed architecture discovers the major intents of the query, including major URLs and attributes. Click-through log data as well as the subsume relations between queries are employed to mine intents of queries. For example, the queries “fast enterprise search”, “fast game”, “fast movie”, etc., all contain the query “fast”. The queries “fast enterprise search”, “fast game”, “fast movie” are referred to as expanded queries of the query “fast”.

The architecture uses the click-through data of both the original query “fast” as well as the expanded queries to find the intents of the original query “fast”. If some uniform resource locators (URLs) are clicked in the searches of the same expanded queries, then the URLs are clustered. Furthermore, if some URLs are co-clicked (according to some frequency) under the same query (either original query or expanded queries), the URLs can also be clustered. The clustered URLs by the two methods are further clustered to create larger clusters of URLs.

The clusters represent the intents of the original query. The URLs associated with each cluster are the major URLs for the corresponding intent. Moreover, expanded terms (e.g., movie, enterprise search, etc.) are referred to as attributes of the intents are also associated with clusters. The mined intents can accurately represent the search intents of users as reflected in the user click-through data. A heuristic pruning algorithm is also provided that can discard false expanded queries (e.g., “fast food” for the query “fast”).

The mined intents can be used to improve various aspects of searching. For example, intents can be used to improve the search user interface (UI). When the search result of “fast” is shown to the user, the intents of the query mined from the search log data can also be shown to the user.

Each intent is described by its major attributes. If the user clicks one of the intents, the URLs belonging to the current intent shown in the current search result can be re-ranked higher, and the URLs related to the other intents will be ranked lower.

Given the search log data, relationships can be structured. For example, a query tree can be constructed where each parent node corresponds to a query. The child nodes represent the expanded queries of the query in the parent node. For example, “fast movie” and “fast game” are child nodes of the parent node query “fast”. Additionally, the clicked URLs of each query are also associated with the node of the query. This is true for both the parent node and the child nodes.

A pruning algorithm can be applied to the query tree to remove unwanted or non-relevant nodes. Not all the child nodes represent real expanded queries. For example, “fast food” should not be viewed as an expanded query of fast. Accordingly, the pruning algorithm will remove this node. In order to perform pruning, the algorithm looks at the clicked URLs associated with the parent node and its child node(s). If a child node does not share any clicked URLs with the parent node and its sibling nodes, the child node is pruned. For example, “fast food” does not share any clicked URL with “fast”, “fast game”, etc., and thus, the subtree under the node associated with “fast food” is pruned. The pruned subtrees can be used as other (small) query trees. The pruning algorithm can be applied to the pruned subtrees as well.

A clustering algorithm is then applied to obtain the intents of each query. Any conventional clustering algorithm can be utilized. For each node, first, the co-clicked URLs are clustered (the URLs that are clicked in the same searches are called co-clicked URLs). An assumption is that co-clicked URLs have the same intent. As a result, each node contains several clusters of co-clicked URLs. If two child nodes (expanded queries) share many attributes and/or the attributes of the child nodes are similar (e.g., synonyms, stemming difference, etc.), then the URLs as well as the attributes of the child nodes are further merged into a cluster. Additionally, the co-clicked URL clusters of the parent node can also be merged into one of the child clusters. A merging process is applied to all the nodes on the tree.

Finally, clusters are output as the intents of the query. Each intent includes the major URLs (high frequency URLs) and major attributes (high frequency expanded terms).

It is to be appreciated that the disclosed architecture can also be applied in other ways such as for image searching (and/or other content types), as well as other types of searching such as personalized searches. With respect to personalized searches, if a user consistently clicks the URLs of one intent of a query (e.g., a particular make and model of car), then the search can rank (e.g., always) the URLs related to the intent, higher. Moreover, the mining task is not limited to URLs. The accuracy of the mining can be improved by separately or in combination therewith considering content of the URLs, for example.

When using click-through data to perform extraction and clustering, it is also within contemplation of the disclosed architecture to consider other information such as IP (Internet protocol) addresses of the users to detect potential click-spam, as well as to enhance the utility of the architecture.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

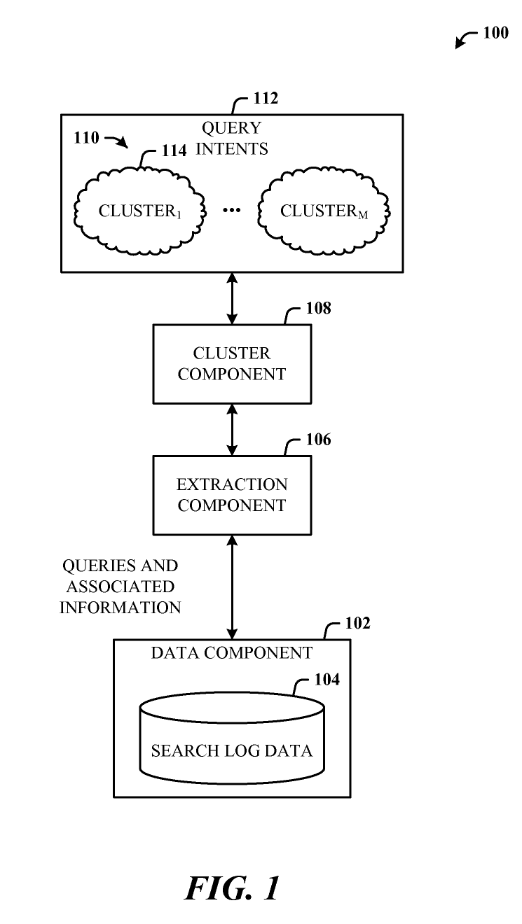

FIG. 1 illustrates an intent mining system 100 in accordance with the disclosed architecture. The system 100 includes a data component 102 of search log data 104. The search log data 104 includes queries and associated information (e.g., query, clicked URLs, frequency of clicked URLs, IP address, clicked time, etc.). An extraction component 106 extracts a subset of search log data associated with a query based on user interaction data (e.g., clicks). A cluster component 108 aggregates (e.g., clusters) the subset of search log data and outputs clusters 110 that represent query intents 112 related to the query.

The search log data 104 can include uniform resource locator (URL) data associated with the query and expanded queries related to the query. The user interaction data can be click-through data of the query and click-through data of expanded queries associated with the query, and optionally, content data associated with the URL of the click-through data. A cluster (e.g., a first cluster 114) includes a URL that is a primary URL of the query intent of the cluster.

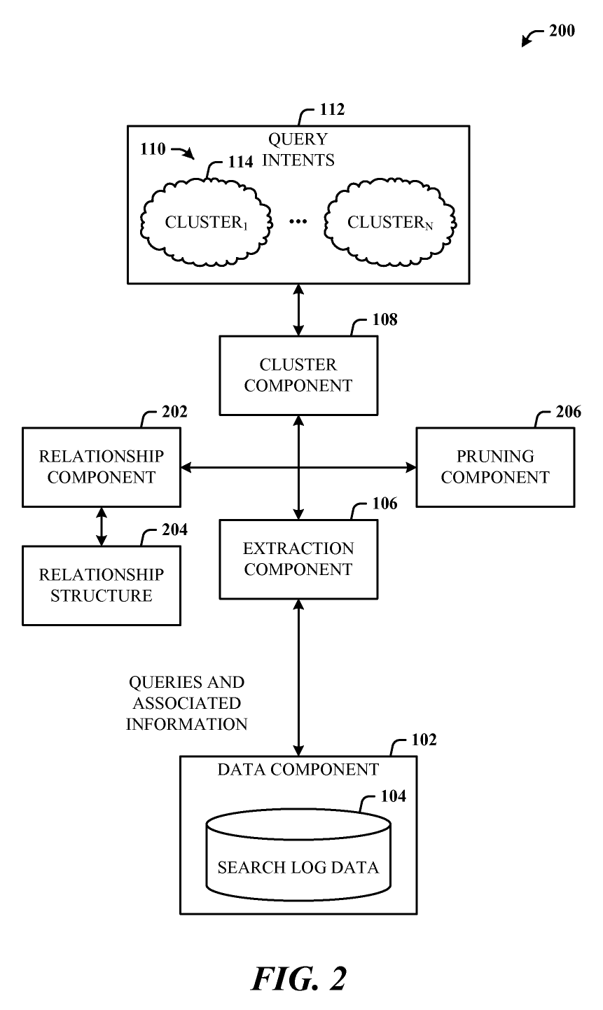

FIG. 2 illustrates an alternative embodiment of an intent mining system 200. The system 200 includes the entities and components of the system 100 of FIG. 1, but in addition, other components. For example, a relationship component 202 constructs relationships between the query and associated expanded queries as a relationship structure 204. A pruning component 206 prunes non-relevant expanded queries from the relationship structure 204. The relationship structure 204 can be a query tree, for example, having parent nodes of queries and child nodes of expanded queries. The pruning component 206 prunes child nodes of non-relevant expanded queries, and the cluster component 108 aggregates co-clicked URLs of parent nodes, as well as co-clicked URLs of the associated child nodes into the same clusters. The relationship structure 204 can be a query tree having parent nodes of queries and child nodes of expanded queries, and the cluster component 108 further aggregates URLs of child nodes having at least one of same attributes or similar attributes, into the same cluster.

Note that as illustrated in this embodiment, the relationship component 202 and pruning component 206 are located between the extraction component 106 and the cluster component 108 such that each component can communicate with each other, should that interface be desired. However, in an alternative embodiment, communications flow is not directly from the extraction component 106 to the cluster component 108, but from the extraction component 106 through either or both of the relationship component 202 or/and pruning component 206, and then to the cluster component 108.

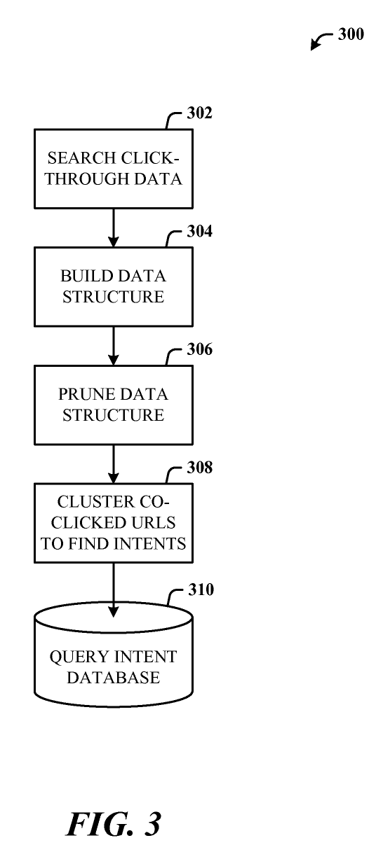

FIG. 3 illustrates a flow diagram 300 of intents mining using a query tree relationship structure. Note that although described as a tree relationship in this example, it is to be appreciated that other types of data relationship structures can be alternatively employed. Flow begins at 302 by searching for click-through data in search log data. At 304, a data structure (e.g., query tree) is built. The structure includes parent-child relationships between queries and expanded queries (e.g., parent nodes (queries) and child nodes (of expanded queries) of a query tree). At 306, pruning is performed to remove non-relevant expanded queries. At 308, clustering of co-clicked URLS is performed to find query intents. At 310, a database of query intents is created and maintained.

Note that as the search log data changes, the output intents can also change, but not necessarily. Thus, the flow diagram 300 can be executed repeatedly to create the latest intents from the user click-through data, as well as any changes that may occur in URL data. Note that the disclosed architecture is not limited to utilization with web searches, but can be used on smaller contexts such as enterprise searches, for example.

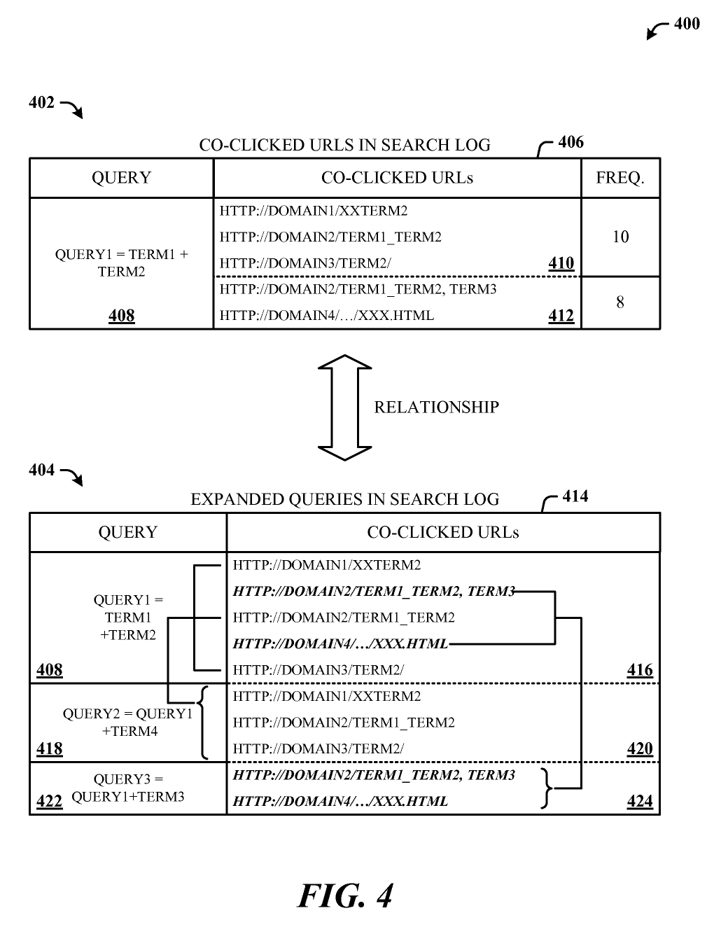

FIG. 4 illustrates an example of search log data 400 as queries 402 and expanded queries 404 in search log data in accordance with the disclosed architecture. With respect to user search behaviors, co-clicked URLs of queries reflect user search intents. Users tend to click URLs with the same intent in each search. Additionally, co-clicked URLs in each search share the same search intent. Moreover, users often add words to specific search intents. Thus, the relationships between queries and expanded queries are useful.

The co-clicked URL records 402 are depicted as a table 406 that shows a first query 408 and co-clicked URLs grouped for different frequencies (e.g., ten and eight). When the user enters the first query 408, the user is presented with webpage listings some of which can be clicked when the user deems these URLs may satisfy the user search. This is co-click data. The co-clicked URLs are grouped in two groups: a first group 410 where the URLs have been clicked with a frequency of ten and a second group 412 where the URLs have been clicked with a frequency of eight. In other words, when a search results page is presented, at least these five URLs can be shown at top ranked, and the user clicks the URLs of the first group 410 at a higher frequency than the URLs of the second group 412.

Related to the first query 408 are the expanded queries 404. The expanded queries 404 are depicted in a table 414 that shows three queries: the first query 408 and associated third group 416 of URLs that includes the URLs of the first group 410 and second group 412 (in bold italics), a first expanded query 418 and associated fourth group 420 of URLs (the results are the same as the first group 410), and a second expanded query 422 and associated fifth group 424 of URLs.

In other words, the first query 408 returns the five URLS in the third group 416, while the first expanded query 418 returns a more narrowed result set of three of the URLs of the third group 416, and the second expanded query 422 returns a more narrowed result set of two of the URLs of the third group 416.

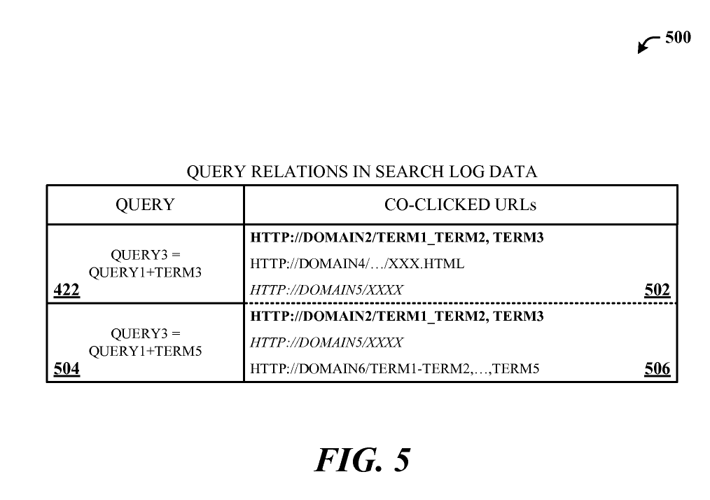

FIG. 5 illustrates query relations 500 in search log data. Here, the previous second expanded query 422 can return a sixth group 502 of three co-clicked URLs and a new expanded query 504 can return a seventh group 506 of co-clicked URLs. Similarity can be measured based on the two bolded URLs—one in each of the groups (502 and 506). Similarity can also be measured based on the two italicized URLS—one in each of the groups (502 and 506).

Note that in addition to that illustrated in FIG. 4 and FIG. 5, term+query (e.g., if “defender” is the query, related queries can be “<App1> defender”, <App2> defender”, where App1 and App2 are different applications, etc.) can be processed, as well as query+attribute and attribute+query.

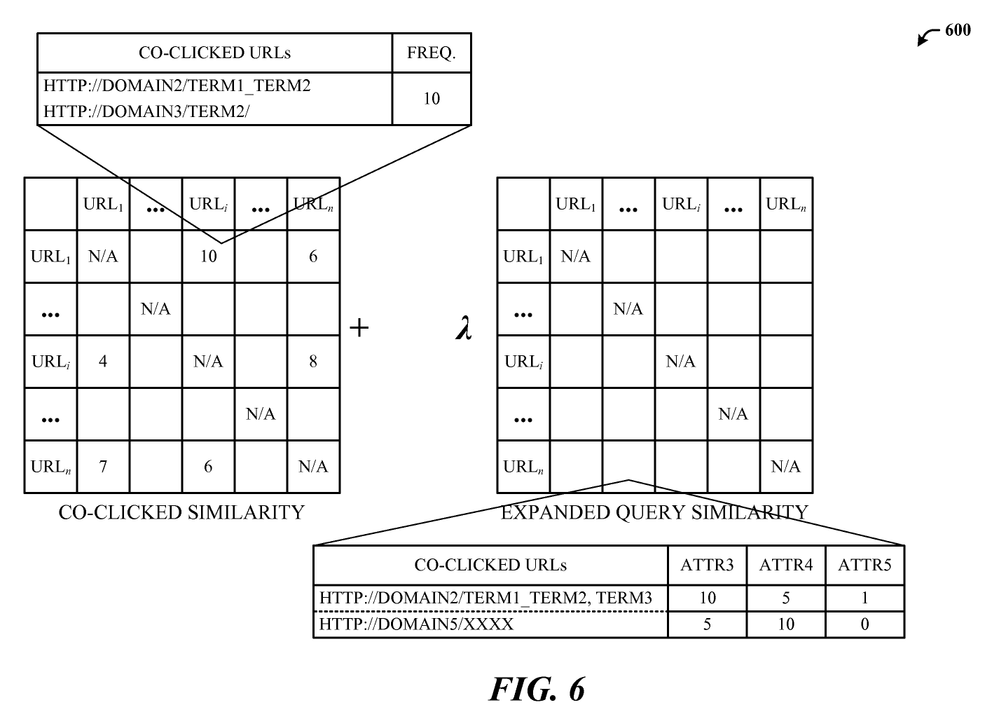

FIG. 6 illustrates a clustering process 600 for clustering URLs to generate intents. As shown, the clustering can be based on co-clicked URL similarity and expanded query similarity. Each cluster equates to intent. Clustering is performed on URLs associated with each query (query node) and on expanded queries (child nodes). Each cluster includes a list of attributes (in expanded queries) as well as major URLs. Major URLs are the URLs clicked in searches of the query and expanded queries.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

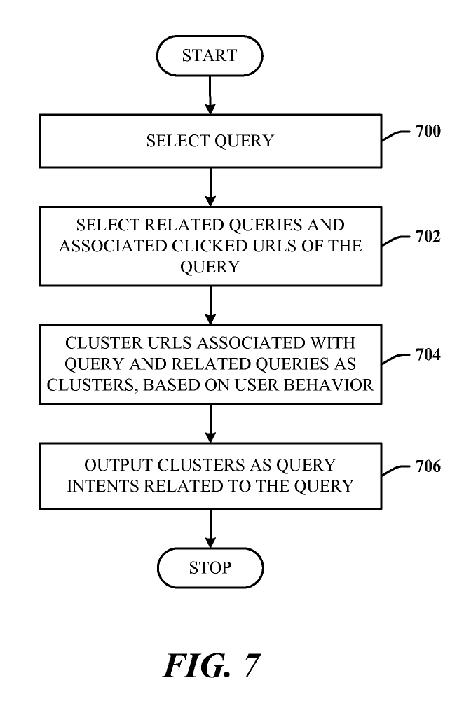

FIG. 7 illustrates a computer-implemented intent mining method in accordance with the disclosed architecture. At 700, a query is selected. At 702, related queries and associated clicked URLs of the query are selected. At 704, the URLs associated with the query and the related queries (e.g., expanded queries) are clustered, based on user behavior. User behavior includes implicit behavior such as co-clicking URLs in one search, as well as explicit behavior such as changing queries, but clicking similar URLs (and not prevented from adding additional words after the query). At this point, a query of a given URL cluster can be selected from the associated queries as a label for that given URL cluster. At 706, the clusters are output as query intents related to the query.

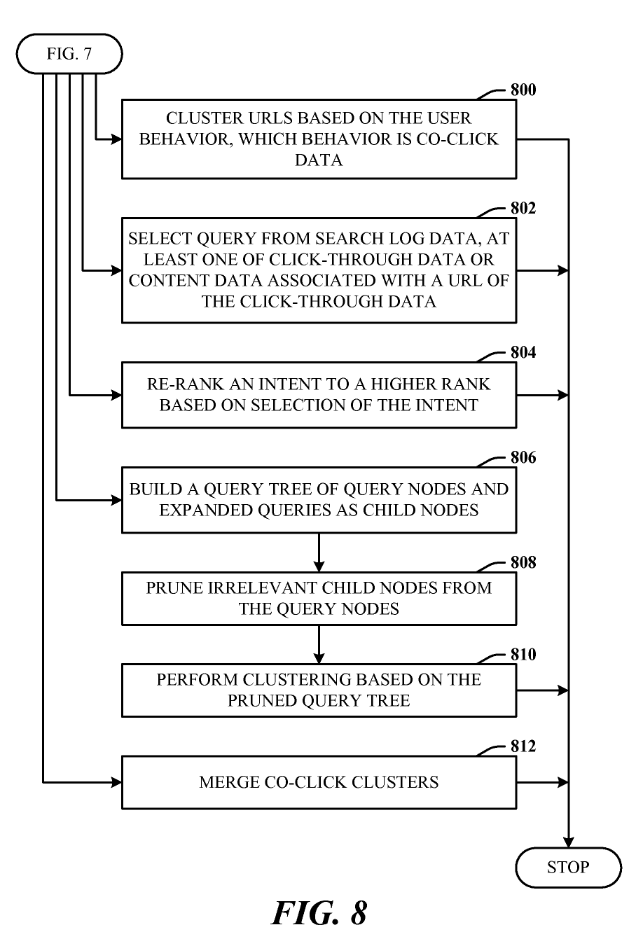

FIG. 8 illustrates further aspects of the method of FIG. 7. Note that the flow indicates that each block can represent a step that can be included, separately or in combination with other blocks, as additional aspects of the method represented by the flow chart of FIG. 7. At 800, the URLs are clustered based on the user behavior, which behavior is co-click data. At 802, the query is selected from search log data, which includes at least one of click-through data or content data associated with a URL of the click-through data. The query and the expanded queries are defined as URLs which have been selected. At 804, an intent is re-ranked to a higher rank based on selection of the intent. At 806, a query tree of query nodes and expanded queries as child nodes is built. At 808, irrelevant child nodes are pruned from the query nodes. At 810, clustering is performed based on the pruned query tree. At 812, co-clicked clusters are merged.

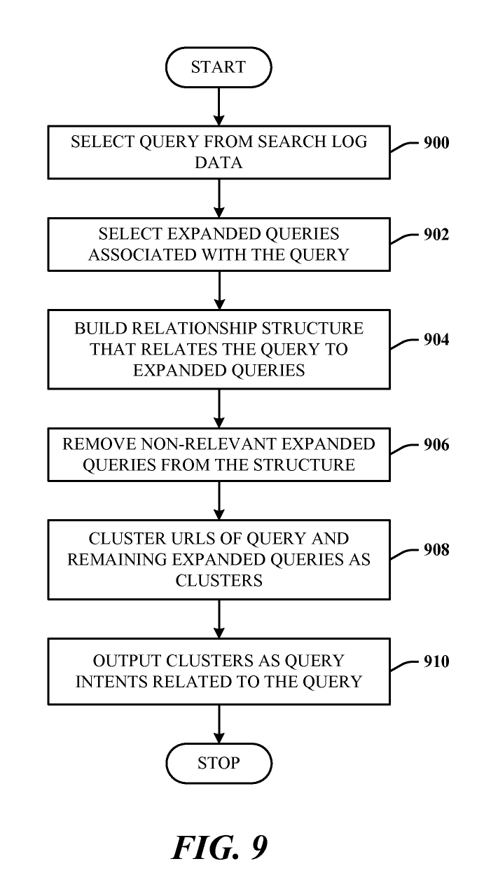

FIG. 9 illustrates an alternative intent mining method in accordance with the disclosed architecture. At 900, a query is selected from search log data. At 902, expanded queries associated with the query are selected. At 904, a relationship structure is built that relates the query to expanded queries. At 906, non-relevant expanded queries are removed from the structure. At 908, URLs related to the query and remaining expanded queries are clustered as clusters. At 910, the clusters are output as query intents related to the query.

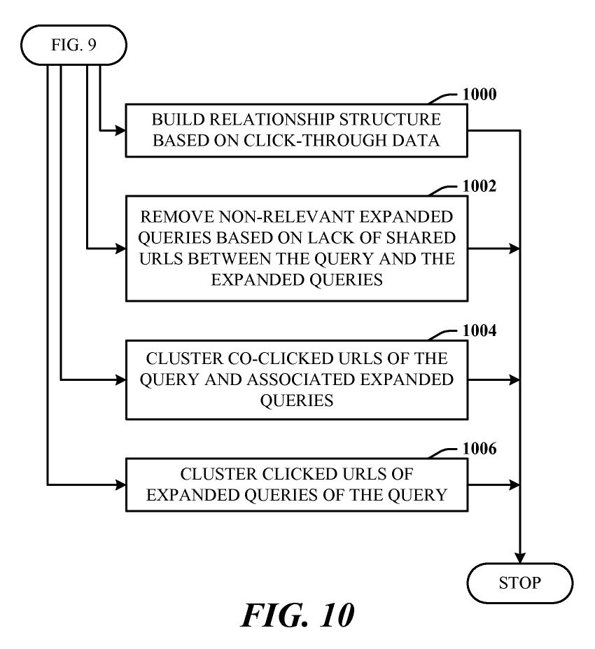

FIG. 10 illustrates further aspects of the method of FIG. 9. Note that the flow indicates that each block can represent a step that can be included, separately or in combination with other blocks, as additional aspects of the method represented by the flow chart of FIG. 9. At 1000, the relationship structure is built based on click-through data. At 1002, the non-relevant expanded queries are removed based on lack of shared URLs between the query and the expanded queries. At 1004, co-clicked URLs of the query and associated expanded queries are clustered. At 1006, clicked URLs of expanded queries of the query can be clustered.

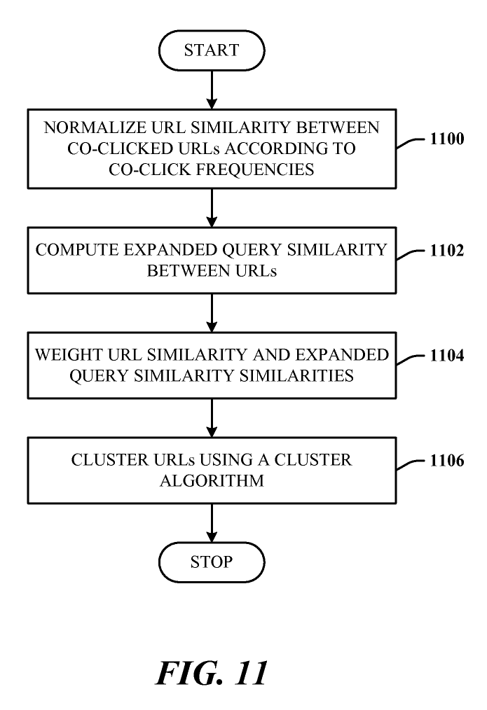

FIG. 11 illustrates an alternative method of intent mining. At 1100, similarity between co-clicked URLs is normalized according to co-click frequencies. At 1102, expanded query similarity between URLs is computed. The similarity is computed by representing each URL as a vector of clicked numbers in expanded queries. At 1104, the URL similarity and expanded query similarity are weighted. At 1106, the URLs are clustered performed based on the weights. The clustering can be accomplished using an algorithm such as agglomerative clustering.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

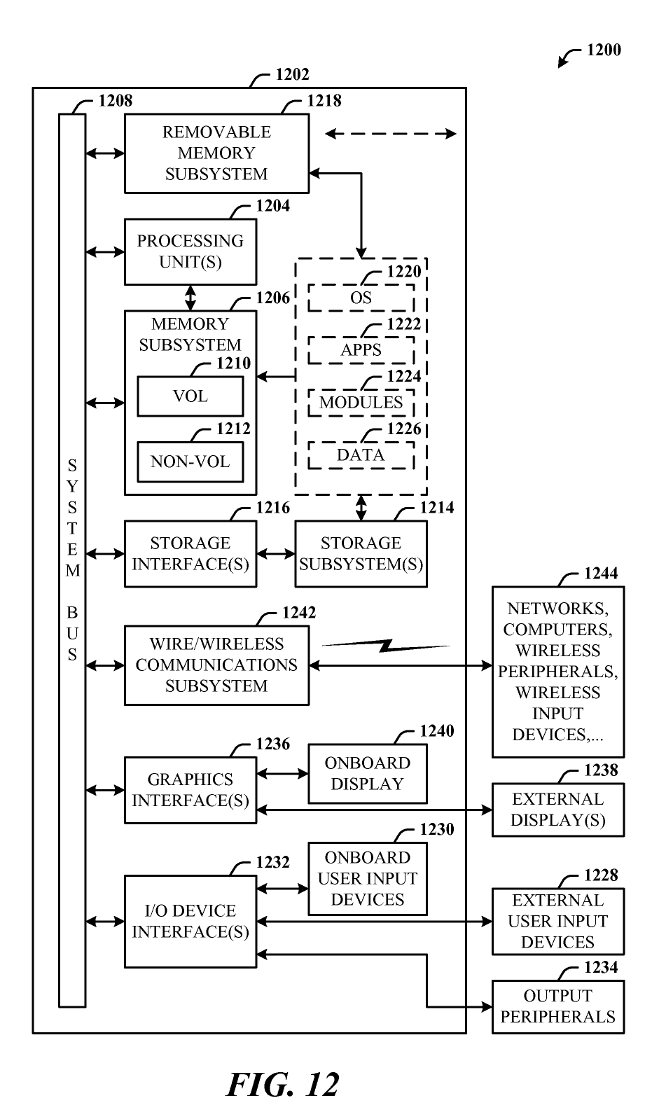

Referring now to FIG. 12, there is illustrated a block diagram of a computing system 1200 that executes intent mining in accordance with the disclosed architecture. However, it is appreciated that the some or all aspects of the disclosed methods and/or systems can be implemented as a system-on-a-chip, where analog, digital, mixed signals, and other functions are fabricated on a single chip substrate. In order to provide additional context for various aspects thereof, FIG. 12 and the following description are intended to provide a brief, general description of the suitable computing system 1200 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1200 for implementing various aspects includes the computer 1202 having processing unit(s) 1204, a computer-readable storage such as a system memory 1206, and a system bus 1208. The processing unit(s) 1204 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 1206 can include computer-readable storage (physical storage media) such as a volatile (VOL) memory 1210 (e.g., random access memory (RAM)) and non-volatile memory (NON-VOL) 1212 (e.g., ROM, EPROM, EEPROM, etc.). A basic input/output system (BIOS) can be stored in the non-volatile memory 1212, and includes the basic routines that facilitate the communication of data and signals between components within the computer 1202, such as during startup. The volatile memory 1210 can also include a high-speed RAM such as static RAM for caching data.

The system bus 1208 provides an interface for system components including, but not limited to, the system memory 1206 to the processing unit(s) 1204. The system bus 1208 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1202 further includes machine readable storage subsystem(s) 1214 and storage interface(s) 1216 for interfacing the storage subsystem(s) 1214 to the system bus 1208 and other desired computer components. The storage subsystem(s) 1214 (physical storage media) can include one or more of a hard disk drive (HDD), a magnetic floppy disk drive (FDD), and/or optical disk storage drive (e.g., a CD-ROM drive DVD drive), for example. The storage interface(s) 1216 can include interface technologies such as EIDE, ATA, SATA, and IEEE 1394, for example.

One or more programs and data can be stored in the memory subsystem 1206, a machine readable and removable memory subsystem 1218 (e.g., flash drive form factor technology), and/or the storage subsystem(s) 1214 (e.g., optical, magnetic, solid state), including an operating system 1220, one or more application programs 1222, other program modules 1224, and program data 1226.

The operating system 1220, one or more application programs 1222, other program modules 1224, and/or program data 1226 can include the entities and components of the system 100 of FIG. 1, the entities and components of the system 200 of FIG. 2, the entities and flow of the diagram 300 of FIG. 3, the search log data 400 of FIG. 4, the relations 500 of FIG. 5, the clustering process 600 of FIG. 6, and the methods represented by the flowcharts of FIGS. 7-11, for example.

Generally, programs include routines, methods, data structures, other software components, etc., that perform particular tasks or implement particular abstract data types. All or portions of the operating system 1220, applications 1222, modules 1224, and/or data 1226 can also be cached in memory such as the volatile memory 1210, for example. It is to be appreciated that the disclosed architecture can be implemented with various commercially available operating systems or combinations of operating systems (e.g., as virtual machines).

The storage subsystem(s) 1214 and memory subsystems (1206 and 1218) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 1202 and includes volatile and non-volatile internal and/or external media that is removable or non-removable. For the computer 1202, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 1202, programs, and data using external user input devices 1228 such as a keyboard and a mouse. Other external user input devices 1228 can include a microphone, an IR (infrared) remote control, a joystick, a game pad, camera recognition systems, a stylus pen, touch screen, gesture systems (e.g., eye movement, head movement, etc.), and/or the like. The user can interact with the computer 1202, programs, and data using onboard user input devices 1230 such a touchpad, microphone, keyboard, etc., where the computer 1202 is a portable computer, for example. These and other input devices are connected to the processing unit(s) 1204 through input/output (I/O) device interface(s) 1232 via the system bus 1208, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 1232 also facilitate the use of output peripherals 1234 such as printers, audio devices, camera devices, and so on, such as a sound card and/or onboard audio processing capability.

One or more graphics interface(s) 1236 (also commonly referred to as a graphics processing unit (GPU)) provide graphics and video signals between the computer 1202 and external display(s) 1238 (e.g., LCD, plasma) and/or onboard displays 1240 (e.g., for portable computer). The graphics interface(s) 1236 can also be manufactured as part of the computer system board.

The computer 1202 can operate in a networked environment (e.g., IP-based) using logical connections via a wired/wireless communications subsystem 1242 to one or more networks and/or other computers. The other computers can include workstations, servers, routers, personal computers, microprocessor-based entertainment appliances, peer devices or other common network nodes, and typically include many or all of the elements described relative to the computer 1202. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1202 connects to the network via a wired/wireless communication subsystem 1242 (e.g., a network interface adapter, onboard transceiver subsystem, etc.) to communicate with wired/wireless networks, wired/wireless printers, wired/wireless input devices 1244, and so on. The computer 1202 can include a modem or other means for establishing communications over the network. In a networked environment, programs and data relative to the computer 1202 can be stored in the remote memory/storage device, as is associated with a distributed system. It will be appreciated that the network connections shown are exemplary and other means of establishing a communications link between the computers can be used.

The computer 1202 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

The illustrated and described aspects can be practiced in distributed computing environments where certain tasks are performed by remote processing devices that are linked through a communications network. In a distributed computing environment, program modules can be located in local and/or remote storage and/or memory system.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented intent mining system, comprising:
a data component of search log data associated with corresponding queries;
an extraction component that extracts a subset of search log data associated with a query based on user interaction data;
a cluster component that aggregates the subset of search log data and outputs clusters that represent query intents related to the query; and
a processor that executes computer-executable instructions associated with at least one of the extraction component or cluster component.

2. The system of claim 1, wherein the search log data includes uniform resource locator (URL) data associated with the query and expanded queries related to the query.

3. The system of claim 1, wherein the user interaction data is click-through data of the query and click-through data of expanded queries associated with the query, and optionally, content data associated with a URL of the click-through data.

4. The system of claim 1, wherein a cluster includes a URL that is a primary URL of the query intent of the cluster.

5. The system of claim 1, further comprising a relationship component that constructs relationships between the query and associated expanded queries as a relationship structure.

6. The system of claim 5, further comprising a pruning component that prunes non-relevant expanded queries from the relationship structure.

7. The system of claim 6, wherein the relationship structure is a query tree having parent nodes of queries and child nodes of expanded queries, the pruning component prunes child nodes of non-relevant expanded queries and the cluster component aggregates co-clicked URLs of parent nodes as well as co-clicked URLs of the child nodes into same clusters.

8. The system of claim 6, wherein the relationship structure is a query tree having parent nodes of queries and child nodes of expanded queries, and the cluster component further aggregates URLs of child nodes having at least one of same attributes or similar attributes into a cluster.

9. A computer-implemented intent mining method, comprising acts of:
selecting a query;
selecting related queries and associated clicked URLs of the query;
clustering URLs associated with the query and related queries as clusters, based on user behavior;
outputting the clusters as query intents related to the query; and
utilizing a processor that executes instructions stored in memory to perform at least one of the acts of selecting, clustering, or outputting.

10. The method of claim 9, further comprising clustering the URLs based on the user behavior, which behavior is co-click data.

11. The method of claim 9, further comprising selecting the query from search log data, which includes at least one of click-through data or content data associated with a URL of the click-through data.

12. The method of claim 9, wherein the URLs are of the query and the related queries which have been selected.

13. The method of claim 9, further comprising re-ranking an intent to a higher rank based on selection of the intent.

14. The method of claim 9, further comprising:
building a query tree of query nodes and expanded queries as child nodes;
pruning irrelevant child nodes from the query nodes; and
performing clustering based on the pruned query tree.

15. The method of claim 9, further comprising merging co-click clusters.

16. A computer-implemented intent mining method, comprising acts of:
selecting a query from search log data;
selecting expanded queries associated with the query;
building a relationship structure that relates the query to expanded queries;
removing non-relevant expanded queries from the structure;
clustering URLs related to the query and remaining expanded queries as clusters;
outputting the clusters as query intents related to the query; and
utilizing a processor that executes instructions stored in memory to perform at least one of the acts of selecting, building, removing, clustering, or outputting.

17. The method of claim 16, further comprising building the relationship structure based on click-through data.

18. The method of claim 16, further comprising removing the non-relevant expanded queries based on lack of shared URLs between the query and the expanded queries.

19. The method of claim 16, further comprising clustering co-clicked URLs of the query and associated expanded queries.

20. The method of claim 16, further comprising clustering clicked URLs of expanded queries of the query.
